(19) United States
(12) Patent Application Publication
(10) Pub. No.: US 2006/0113847 A1
(43) Pub. Date: Jun. 1, 2006

(54) Linear actuator

(76) Inventors: James William Arthur Randall, Dorset (GB); Philip John Sibley, Dorset (GB)

Correspondence Address: GIFFORD, KRASS, GROH, SPRINKLE & CITKOWSKI, P.C, PO BOX 7021, TROY, MI, 48007-7021, US

(21) Appl. No.: 10/546,116

(22) PCT Filed: Feb. 19, 2004
(86) PCT No.: PCT/GB04/00660

§ 371 Date: Nov. 3, 2005

(30) Foreign Application Priority Data
Feb. 19, 2003 (GB) 03038064

(51) Int. Cl. H02K 41/00

(52) U.S. Cl. 310/12

(57) ABSTRACT

A linear electromagnetic machine comprises two relatively movable members with an array of coils on one member and a plurality of magnets of alternating polarity on the other whereby to generate a magnetic field which intersects a current flowing in the coils in such a way as to give rise to a mechanical force between the two members. The coils are encased within an outer casing having a plurality of generally elongate fins to encourage the transfer of heat from the coils to the environment. The relative positions of the coils and the magnets sensed by a position transducer and the coils are grouped in modular units which can be supplied independently by one or more power supply and control unit such that coils can be selectively energized in dependence on the relative positions of the magnets and the coils.

The present invention relates generally to a linear actuator, and particularly to an improved linear actuator capable of providing a high force and a rapid application of force.

Although the present invention will be described herein as a linear actuator it may more properly be referred to as a linear electromagnetic machine in that relative movement of two parts of the machine may be employed for other purposes than merely to obtain displacement of components to which the actuator may be attached. For example, a machine may be formed as a pump having a closed chamber and a movable member within the chamber without there being an actuator rod or arm extending from a fixed member of the machine.

In general, a linear electromagnetic machine or actuator may be formed comprising an armature which is urged to move within a stator by electromagnetic forces produced by interactions between magnetic fields and electric currents flowing in coils. The magnetic fields may be produced by permanent magnets or by electromagnets forming part of the armature, in which case the coils correspondingly form part of the stator. An opposite configuration in which the coils form part of the armature and the permanent magnets or electromagnets form part of the stator is also within the scope of this invention. Indeed, in this context, the terms “stator” and “armature” are not intended to limit the components to being a stationary and a moving part respectively since relative motion occurs between the two parts so that, depending on the mechanical configuration, either may be a stationary member with respect to which the other moves, or both may be movable with respect to a fixed frame of reference.

Such machines maybe used to produce linear motion or to maintain the position of a body against forces exerted upon it. Regardless of whether the machine is formed as a pump, an actuator or any other form of machine, one most important consideration is the thrust which can be generated by the electromagnetic interaction between the current flowing in the coils and the magnetic field. The thrust of such an electromagnetic machine is related directly to the flux density of the magnetic field, the current in the coil and the overall length of the path of the current, that is the wire in the coil. In a configuration in which the magnetic field is produced by permanent magnets surrounded by circumferential coils it can be seen that radial magnetic fields and particularly suitable for intersection with the current. Radial magnetic fields may be produced by radial magnetization of permanent magnets. This, however, has particular difficulties due to the stresses on the magnetic material and it is preferred that axially magnetized magnets are used in an array of alternating opposite polarity with pole pieces between each pair of adjacent magnets acting to divert the axial magnetic field into a radial direction.

In such a configuration the thrust generated by a linear electromagnetic machine is directly proportional to the current so that, in order to provide high thrust, high currents are required. This inevitably results in the generation of heat which must be limited in order to avoid damage to the machine itself. Overheating of the coils, for example, can result in degradation of the insulation between adjacent coils and effective shortening of the wire length by short-circuiting adjacent coils. The present invention provides means by which the current flowing in a linear electromagnetic machine can be increased without overheating the machine as will be described in more detail below.

The performance of a linear electromagnetic machine is also affected by the amount of magnetic flux which is caused to intersect the coils. Where the armature comprises magnetized permanent magnets and pole pieces it is important to minimize the so-called “air gap” that is the distance the magnetic field travels from one pole in the magnetic array, or from a face of a pole piece, to the next. The distance between the face of the pole piece and the adjacent surface of the coil can be minimized in order to minimize the air gap. The present invention provides means by which this distance can be minimized by suitable structures of the magnetic array.

Whether the linear electromagnetic machine is one having circumferential coils outside the magnetic array, in which case the heat dissipation to the environment can be achieved directly, or whether the coils are within the magnet array, in which case some form of heat transfer from within the machine is required, the same principles of cooling apply. In either case there is a need for an escape of heat in order to prevent overheating.

According to one aspect of the present invention, therefore, a linear electromagnetic machine of the type comprising two relatively movable members with an array of coils on one member and a plurality of magnets of alternating polarity on the other whereby to generate a magnetic field which intersects a current flowing in the coils in such a way as to give rise to a mechanical force between the two members, is arranged in such a way that the coils are enclosed within an outer casing having a plurality of generally elongate fins projecting from the surface thereof whereby to encourage a transfer of heat from the coils to the environment.

In a preferred embodiment of the invention the coils are securely fixed to the interior surface of the casing in such a way as to form a good thermal contact. This may be achieved, for example, by ensuring that the coils are securely embedded in an adhesive setting material on the inner surface of the outer casing. In order to maximize the coherence of the setting material it should have no voids or air bubbles, and various techniques for ensuring that this is achieved may be employed, including vibration of the assembly during mounting of the coils, and enclosure of the whole assembly within an evacuated environment whilst the adhesive material is setting.

In one embodiment of the invention the magnets are generally planar elements having major faces extending transverse the direction of relative movement between the two said relatively movable members. In this case the magnets have associated pole pieces interposed between them and it is preferred that the axial dimension of the pole pieces between adjacent magnets is substantially less, for example half the axial dimension of the magnets themselves. This concentrates the flux at it is directed to the coils. In a reciprocal configuration in which the coils are formed on a member surrounded by annular magnets an internal former may be provided with inwardly projecting fins within a passage through which a coolant fluid such as cooling air can be caused to pass.

According to another aspect of the present invention a linear electromagnetic machine comprises two relatively movable members, one bearing a plurality of magnets generating magnetic fields of alternating polarity and the other bearing a plurality of coils the current through which interacts with the magnetic fields to cause relative movement between the two members, in which the relative positions of the coils and the magnets are sensed by a position transducer and the coils are grouped in modular units which can be supplied independently by a power supply and control unit such that coils can be selectively energized in dependence on the relative position of the magnets and the coils.

The construction of Linear electromagnetic machines using coils in modular units has a number of advantages. For example, it can it shown that the relationship between the force transmitted between the stator and armature in motion is affected by the way in which the coils are connected to the power supply. A three-phase system in which the coil are connected to a power supply in the so-called delta configuration gives a better force/velocity ratio than one in which the coils are connected in the so-called star configuration. That is, although higher, forces can be achieved, this is at the expense of lower speeds of movement.

By contrast, in the star configuration there is a steeper drop in the force/velicity ratio, although higher speeds can be reached. Thus, it is preferable for the coils to be star-connected at the positions, such as at the ends of a linear machine, where it may be expected that the relative speed of the armature and station will be low but where high thrusts (for example to overcome inertia in a driver system) is required. At positions in the central region of the linear machine (at the mid-stroke region) it may be more important to produce thrust at higher relative speeds and in such circumstances the delta connection provides better results.

By using a modular structure it is possible to have both, although the star-connected coil and the delta-connected coils may need separate power supply units. It is a relatively simple matter therefore to adapt the coil structure in order better to respond to the power and velocity requirements of any particular application.

This is of particular value in the construction of linear actuators having a relatively long stroke in which the magnetic array has a determined length less than the length of the stroke since, at any one time, only a limited number of coils will be cut by the magnetic fields generated by the magnets. Any coils outside the immediate influence of the magnetic fields can therefore be switched off minimizing power consumption and, consequently, therefore, reducing the generation of heat.

The present invention also comprehends the combination of a linear electromagnetic machine as defined hereinabove in combination with a control device for applying current of selected magnitude and polarity to selected coils whereby to energize only those coils in the vicinity of the magnets as detected by the said relative position sensor. In such a configuration it is preferred that the coils are held in good thermal contact with the outer casing and there are means for encouraging the transfer of heat from the casing to the surrounding environment. The fins referred to above may be radially projecting axially extending fins or may have a different configuration depending on the immediate circumstances. For example, radially projecting circumferentially extending fins may be effective in circumstances where a flow of coolant transverse the length of the actuator can be expected or provided.

The present invention also comprehends the combination of a linear electromagnetic machine as defined hereinabove together with means for generating a forced flow of coolant fluid over the fins of the outer casing.

According to a further aspect, the present invention provides a linear electromagnetic machine of the type comprising two relatively movable members within an array of coils on one member and a plurality of magnets of alternating polarity on the other whereby to generate a magnetic field which intersects a current flowing in the coils in such a way as to give rise to a mechanical force between the two members, in which the magnets are in the form of discs secured together by their major faces to form a generally cylindrical array, the outer generally cylindrical surface of the array of magnets being coated with a wear resistant material. The layer of wear resistant material coating the generally cylindrical surface of the magnet array may be extremely thin, for example in the region of 5 microns, and the wear material may be any suitable material for resisting repeated frictional contact with guide members by which the relative movement of the magnet array in relation to the coils may be guided. This wear material may be metal, plastics, carbon fibre or the like.

In such an array the magnets may be secured together by adhesive, or may each have a central hole through which passes a longitudinal shaft or bolt having securing means at each end by which the magnets may be clamped together in an array.

The present invention also comprehends a method of producing a linear electromagnetic machine of the type defined hereinabove including the steps of bonding the coils to the interior surface of an outer casing under vacuum conditions to ensure that the bonding material has no voids or air pockets.

Various embodiments of the present invention will now be more particularly described, by way of example, with reference to the accompanying drawings, in which:

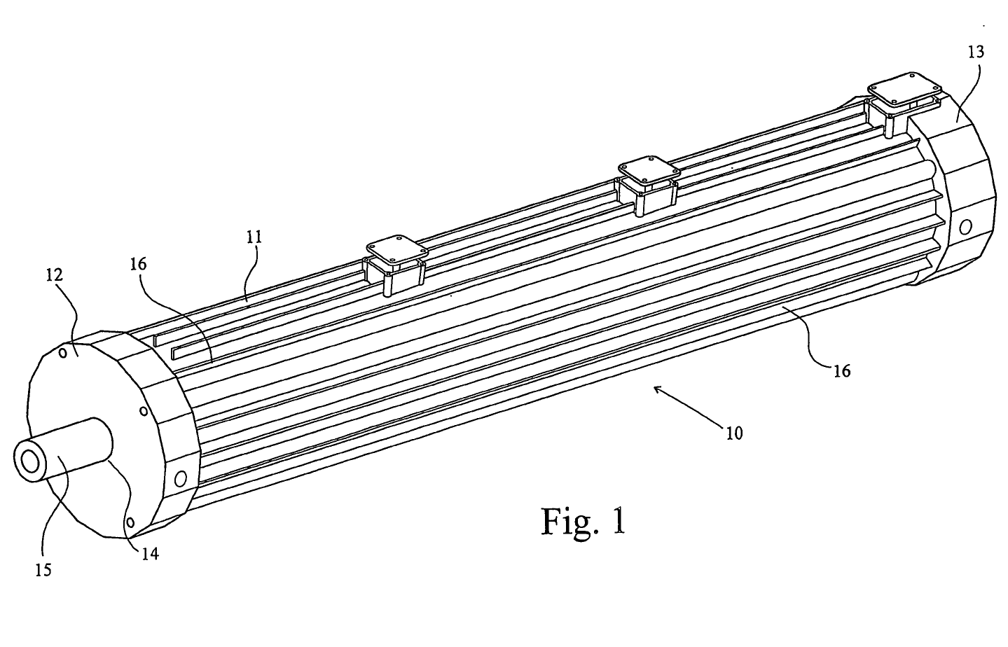

FIG. 1 is a perspective view of an electromagnetic linear actuator formed as a first embodiment of the present invention;

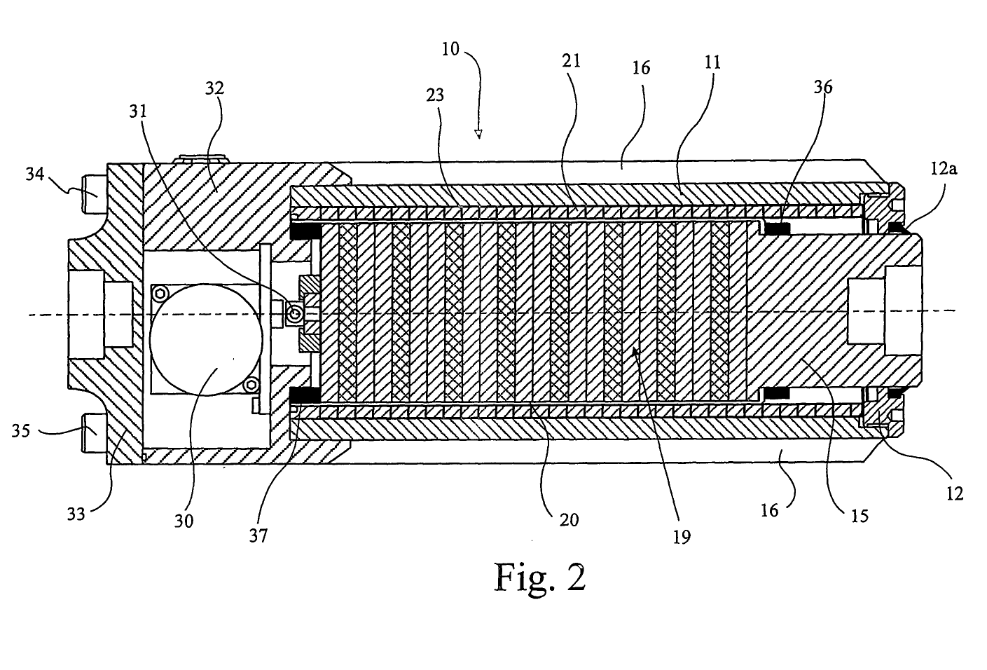

FIG. 2 is an axial sectional view of a second embodiment of the invention;

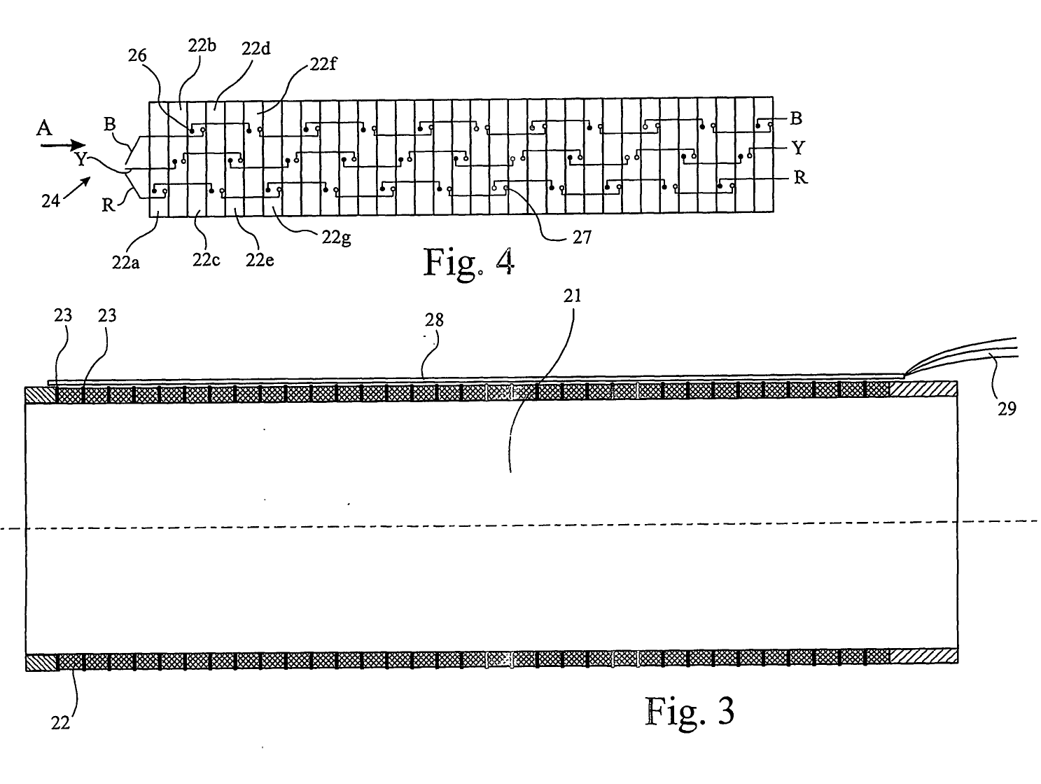

FIG. 3 is a sectional view of a coil assembly suitable for use in a linear actuator formed as an embodiment of the invention;

FIG. 4 is a schematic diagram illustrating the interconnections of the coils in the coil array of FIG. 3;

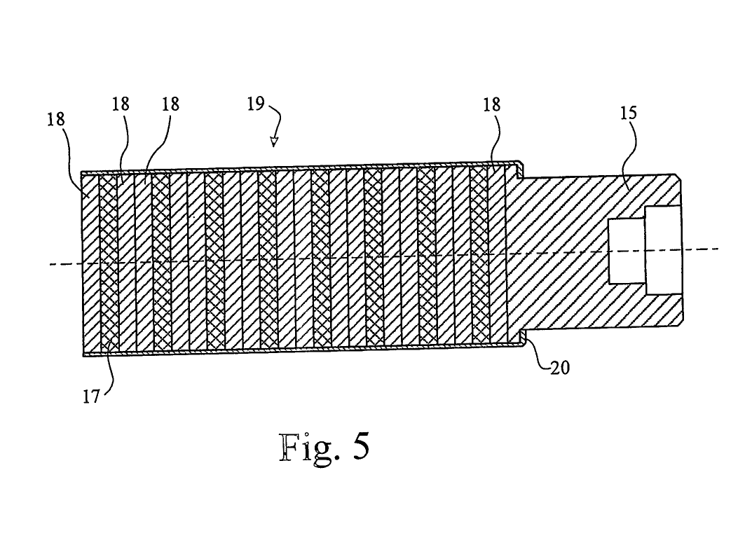

FIG. 5 is an axial sectional view of a magnet array formed in accordance with the principles of the present invention;

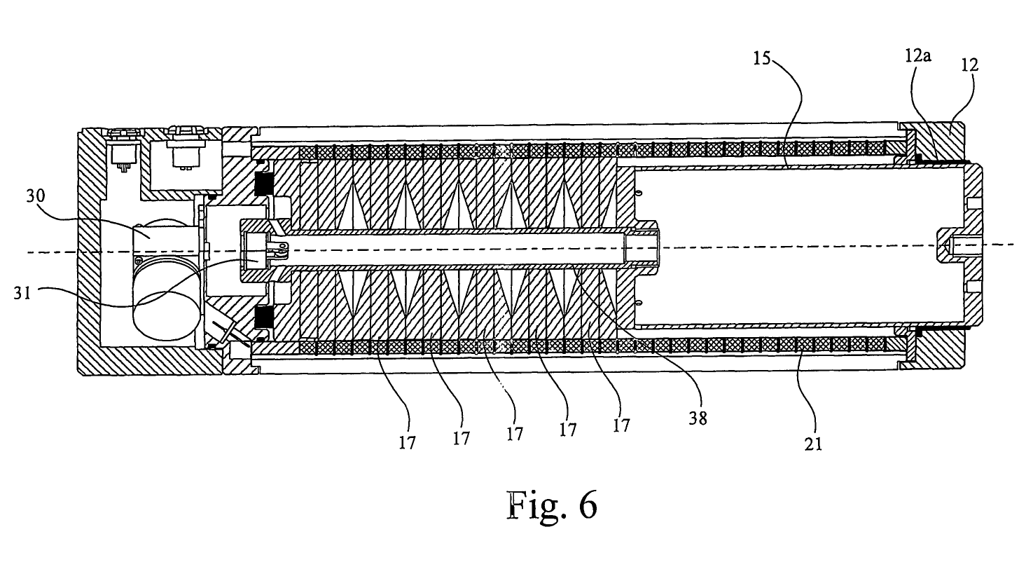

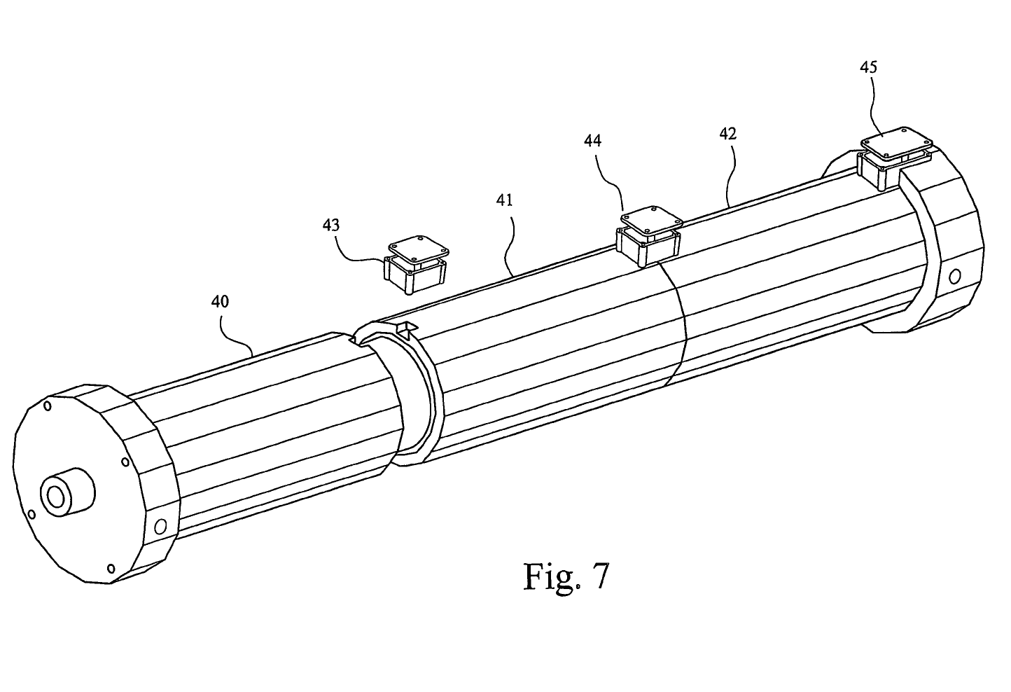

FIG. 6 is an axial sectional view of an alternative embodiment of the present invention;

FIG. 7 is a partly exploded view of an alternative embodiment of the present invention;

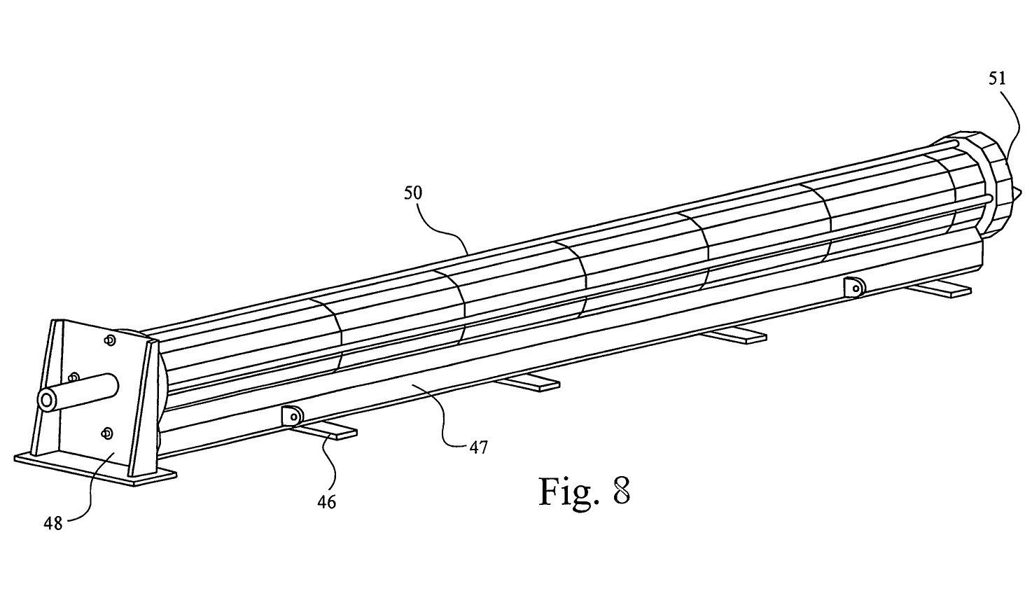

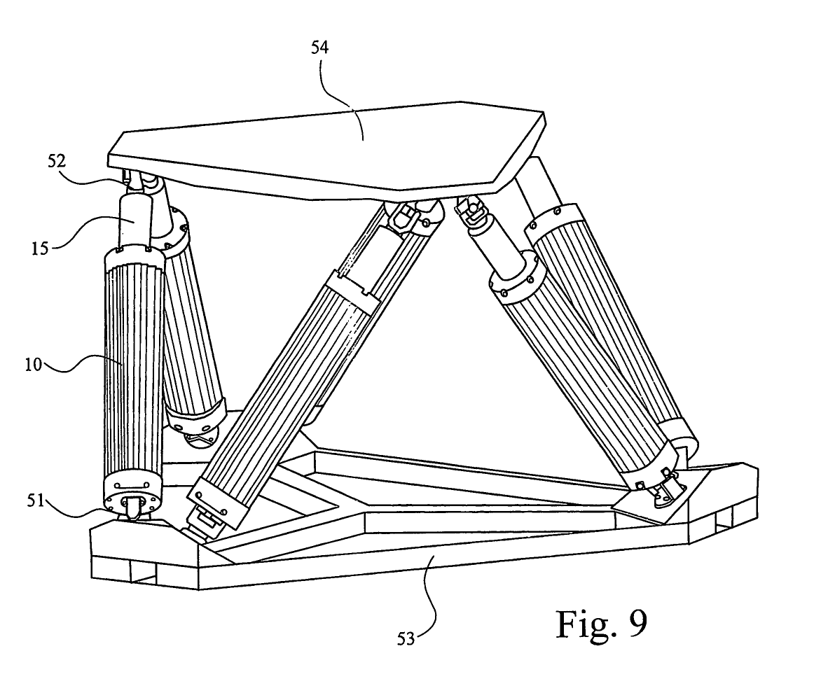

FIG. 8 is a perspective view of a further embodiment of the invention; and

FIG. 9 is a schematic view illustrating a motion base formed using electromagnetic actuators constructed in accordance with the present invention.

Referring first to FIG. 1 there is shown an electromagnetic linear actuator generally indicated 10 comprising an outer case 11 of generally cylindrical form closed by end caps 12, 13 at each end. The end cap 12 has a central opening 14 through which projects an actuator arm or rod 15. The outer surface of the casing 11 has a plurality of radially projecting axially extending fins 16 for cooling purposes as will be described in more detail below.

The interior structure of the actuator 10 illustrated in FIG. 1 can be determined from the following description of the embodiment of FIG. 2 which is not exactly identical in that it is formed as a short stroke ram, although the major components of the interior structure are similar.

Referring now to FIG. 2, the same reference numerals will be used for the same or corresponding components as those appearing in FIG. 1. Thus, the ram generally indicated 10 has an outer casing 11 with a plurality of axial extending radially projecting fins 16. The end cap 12 through which the actuator arm 15 projects is in this embodiment formed as a plug fitting within the end of the casing 11, and the actuator arm 15 itself has a relatively large diameter in relation to its length. The actuator arm 15 is formed as part of a magnet array as illustrated in more detail in FIG. 5. This comprises a plurality of magnets 17 interspersed by pole pieces 18 of substantially similar shape and dimensions. In this embodiment the ram has circular symmetry about its longitudinal axis and the magnets are formed as flat discs, as are the pole pieces 18. Each magnet 17 has a pole piece 18 secured on either face so that two pole pieces 18 are in contact with one another between each pair of magnets 17 so that there is twice the axial dimension of pole piece material between each magnet of a given axial dimension.

This is a structure which may be used if the handling of magnets makes it desirable to have a pole piece on each side of the magnet. For greater flux concentrations, however, it is preferable for the pole piece thickness to be less than the magnet thickness, for example in the region of one half of the magnet thickness. The magnets and pole pieces are secured together in face-to-face relationship by adhesive to form an overall magnet array generally indicated 19, and the outer cylindrical surface of the array 19 is covered with a sleeve 20 of wear-resistant material which may be fitted over the array 19 after the magnets and pole pieces have been secured together, or which may be formed by coating this cylindrical surface to form a very thin layer. Whether formed as an individual sleeve or as a layer over the surface of the magnet and pole piece array the sleeve 20 is of minimum thickness thereby minimizing the “air gap” between the magnets and the coils as will be discussed in more detail herein below.

Referring now to FIGS. 2 and 3 it will be seen that the magnet array 19 is co-axially and slidably housed within a coil array 21 comprising a plurality of individual coils, as illustrated in more detail in FIG. 3, each coil being identified with the reference numeral 22 and each being separated from its neighbour by an insulating spacer 23. The coils are circumferentially formed and flat laid in a fixed plurality of turns as illustrated in FIG. 3 with the tails of each coil being taken out on the same side of the coil so that they may be interconnected in a pattern as illustrated in FIG. 4. From this it will be appreciated that the coils 22 are grouped in sets of three with each third coil being connected together, but of opposite polarity so that only every sixth coil is connected in the same polarity to the same phase of a three phase star connected supply generally indicated 24. In this diagram (FIG. 4) the connecting bridges 25 are shown having solid terminals 26 connecting to a first end of each coil, and open or hollow terminals 27 (that is terminals represented by a circle rather than a filled in dot) connecting to the opposite terminal of each coil. Thus, for example, coil 22a is connected to the R phase line in a configuration which, by way of example, may be considered as a clockwise configuration, that is the current in the coil 22a is supplied on phase R in such a way that the positive half-wave flows clockwise around the coil 22a when viewed from the end A in FIG. 4. The next adjacent coil 22b is similarly connected on the Y phase and the third coil 22c is similarly connected on the B phase.

The fourth coil 22d is connected in the R phase with the input end connected to the output end of the coil 22a such that the current flowing in coil 22d will flow anticlockwise (in the sense defined above). Similarly coils 22e and 22f are connected to flow anticlockwise in relation to the coils 22b and 22c. Thus the seventh coil in the array, identified 22g in FIG. 4, is the first coil connected in the same sense and to the same phase as the first coil 22a. Although shown in an array extending across the circumferential extent of the coils in FIG. 4 it will be appreciated that these taps are all grouped closely together so that the interconnections can be made from a single printed circuit board 28 as illustrated in FIG. 3 from which the leads 29 extend for connection to a control device (not illustrated) by which the three phase lines R, Y, B (Red, Yellow and Blue) selectively in accordance with the motion it is desired to impart to the actuator magnet array.

Returning now to FIG. 2 the precise position of the magnet array 19 is determined by a transducer 30 which is connected by an interconnection 31 to the end of the magnet array 19 remote from the actuator arm 15 so that this remains entirely within the casing 11 during operation of the actuator. The transducer 30 is located within an end body 32 of the actuator, closed by an end cap 33 by which access to the transducer 30 can be gained by removal of fixing screws 34, 35 (in practice there would be more, but only two are visible in the drawing).

In the embodiment illustrated in FIG. 2 the maximum stroke of the actuator arm 15 is determined by two annular end stops 36, 37, the first located on a shoulder of the actuator arm 15 at one end of the magnet array 19 and the other on the body 32 at the other end of the magnet array 19. When the actuator arm 15 is fully retracted the magnet array 19 engages against the end stop 37 between this array and the body 32, and when the actuator arm 15 is fully extended the end stop 36 engages against the inner face of the end cap 12. As will be appreciated the stroke of the actuator illustrated in FIG. 2 is very much less than the length of the magnet array 19, in fact being less than one quarter of its length.

As illustrated in FIG. 1 the outer casing 11 has axial fins 16 for cooling purposes. Thus, when the coils 22 in the coil array 19 are supplied with electricity to generate a displacement between the casing 11 and the actuator arm 15 at high thrust which involves high currents, the heat generated in the coils is dissipated via the fins 16. Maximum interconnection between the electric fields and the magnetic fields is achieved by having reduced the “air gap” to a minimum by utilizing an extremely thin sleeve 20. As explained above, the sleeve 20 may be a metal or non-metallic material such as carbon fibre or plastics, or may be a deposited coating of suitable wear material.

FIG. 6 illustrates a similar embodiment to that of FIG. 2, but of longer stroke, where the same reference numerals are used to identify corresponding components. It will be seen, here, that the actuator arm 15 is hollow and that, instead of disc-shape magnets, the magnets 17 are annular and are held together by a central rod 38. Utilising a central clamping arrangement of this form facilities use of an external coating layer on the outer cylindrical surface of the magnet array 19 rather than a cylindrical sleeve 20 as illustrated in FIG. 5. Also in this case it will be appreciated that there are a significant number of coils in the array which do not directly influence the magnet array in any one position of the actuator arm 15, and in accordance with the principles of this invention those coils which are not directly influencing the magnet array at any one time may have no current passing through them. In order to facilitate this it is necessary for the coils to be grouped in modular units since the connection configuration illustrated in FIG. 4 does not allow individual coils to be isolated and de-coupled from supply when those in the phase to which they relate is supplied. For this purpose a further alternative embodiment as illustrated in FIG. 7 may be employed where, as can be seen, the coil arrays are grouped in three sets 40, 41, 42 each having separate electrical connectors 43, 44, 45. This modular construction is of advantage when manufacturing actuators having a long stroke since any failure in one or more coils can be remedied by replacing just a modular section rather than requiring the whole coil array to be replaced. This is of particular significance in view of the fact that the coils are embedded in a setting material in order firmly to secure them to the casing since this structure does not permit the replacement of an individual failed coil. Firm boding of the coils to the casing, however, is essential when heavy loads are applied by the actuator since the forces generated by the interaction between the currents and the magnetic fields passes through the coils to the casing, and any imperfection in the secure bonding of the coils to the casing will result in relative movement between the coil and the casing, perhaps only in the way of vibration, but such vibration results in operating noise during use of the actuator, which in many circumstances is a considerable disadvantage. Indeed, it is considered an advantage of the actuator of the present invention that it is substantially silent in use.

Another advantage of the modular connection lies in the possibility of locating star-connected soils at the ends of the ram and delta-connected coils towards the middle. This is not shown in the drawings, but results in making best use of the performance characteristics by matching them to the particular exigencies of use in any application.

FIG. 8 illustrates a further alternative embodiment of the invention in which six modular arrays of coils are held together in an assembly. In this embodiment external tie rods hold the coils together rather than mounting them within a fixed casing. This structure is, however, only of use in certain applications where, as illustrated in FIG. 8, the actuator may be mounted by way of a number of feet 46 extending from a sub frame 47 carried by an end plate 48 to which the external tie rods 50 are secured. An end plate 51 at the far end of the actuator from the end plate 48 completes the external assembly and provides a member against which the tension of the tie rods 50 can be applied.

FIG. 9 illustrates an alternative use of the actuator of the invention, in this case formed with a connector 51 at one end of the casing 11 and a connector 52 at the end of the actuator arm 15. The structure shown in FIG. 9 comprises a so-called “Stewart” platform type of motion base, having a lower frame 53 and an upper platform 54 interconnected with the lower frame 53 by six actuators connected at their lower ends in pairs and at their upper end in adjacent pairs allowing the upper platform 54 to be moved with a high degree of freedom by selectively extending or retracting the actuators in accordance with a set of demand signals.

1. A linear electromagnetic machine of the type comprising two relatively movable members with an array of coils on one member and a plurality of magnets of alternating polarity on the other whereby to generate a magnetic field which intersects a current flowing in the coils in such a way as to give rise to a mechanical force between the two members, characterised in that the coils are encased within an outer casing having a plurality of generally elongate fins to encourage the transfer of heat from the coils to the environment.

2. A linear electromagnetic machine according to claim 1 characterised in that the coils are securely embedded in an adhesive setting material on the inner surface of the outer casing.

3. A linear electromagnetic machine according to claim 1, characterised in that the magnets are generally planer elements having major faces transverse the direction of relative movement between the two said relatively movable members.

4. A linear electromagnetic machine according to claim 3, characterised in that the magnets have associated pole pieces interposed between them, the axial dimensions of the pole pieces between adjacent magnets being less than half the axial dimension of the magnets themselves.

5. A linear electromagnetic machine comprising two relatively movable members, one bearing a plurality of magnets generating magnetic fields of alternating polarity and the other bearing a plurality of coils the current through which interacts with the magnetic fields to cause relative movement between the two members, characterised in that the relative positions of the coils and the magnets are sensed by a position transducer and the coils are grouped in modular units which can be supplied independently by one or more power supply and control unit such that coils can be selectively energized in dependence on the relative positions of the magnets and the coils.

6. A linear electromagnetic machine according to claim 5, characterised in that the modular units each comprise a plurality of coils in a three-phase configuration and at least one of the units is star-connected to a three phase power supply and at least one of the units is delta-connected to a three phase power supply.

7. A modular linear electromagnetic machine according to claim 6, characterised in that the delta-connected units are located at the ends of the machine and the star-connected units are located in a central region of the machine.

8. A linear electromagnetic machine as according to claim 5, in combination with a control device for applying currents of selected magnitude and polarity to selected coils whereby to energise only those coils in the near vicinity of the magnets as determined by the said relative position sensor.

9. A linear electromagnetic machine as according to claim 6, in which the coils are held in thermal contact with the outer casing and there are means for encouraging the transfer of heat from the casing to the surrounding environment.

10. A linear electromagnetic machine according to claim 7, in which there are provided means for the forced circumferential flow of coolant fluid over the fins of the outer casing for cooling purposes.

11. A linear electromagnetic machine according to claim 8, characterised in that the magnets are secured together by means which do not protect beyond their outer surfaces and these surfaces are coated with a coating of magnetically transparent material.

12. A linear electromagnetic machine according to claim 9, characterised in that the magnets are secured together by one or more longitudinal shaft or bolt having securing means at each end permitting the transfer of longitudinal forces.

13. A linear electromagnetic machine according to claim 10, characterised in that the maximum stroke of the machine is less than the overall length of the array of magnets.

14. A linear electromagnetic machine according to claim 11, characterised in that the position transducer has means for the positive transmission of displacement movements in two opposite directional senses.

15. A linear electromagnetic machine according to claim 12, characterised in that the magnets are held together within an outer magnet array holder the wall thickness of which is such as not materially to affect the transmission of the magnetic field therethrough.

16. A method of producing a linear electromagnetic machine of the type defined in claim 1 characterised by, including the steps of bonding the coils to the interior surface of the outer casing under vacuum conditions to ensure that the bonding material has no voids or air pockets.
